(19) United States
(12) Patent Application Publication
(10) Pub. No.: US 2003/0125039 A1
(43) Pub. Date: Jul. 3, 2003

(54) Multi-carrier traffic allocation enhancements to reduce access failures and to work across bands

(75) Inventors: Abdennaceaur Lachtar, Richardson, TX (US); Sarvesh Sharma, Plano, TX (US)

Correspondence Address: BRACEWELL & PATTERSON, L.L.P., P.O. BOX 969, AUSTIN, TX, 78767-0969, US

(73) Assignee: Nortel Networks Limited

(21) Appl. No.: 10/034,938

(22) Filed: Dec. 27, 2001

(51) Int. Cl. H04Q 7/20

(52) U.S. Cl. 455/453; 455/452; 455/446

(57) ABSTRACT

The carrier determination algorithm (CDA) used in multi carrier traffic allocation in mobile wireless digital telephony is enhanced. Access failure rates are reduced by the enhancements. One technique is based on selecting the originating carrier if capacity is available on that carrier. Availability of resources on other sections is also considered in selecting a carrier frequency, as is which carriers are data-filled with the same priority when carrier priorities are considered. Consideration is also given to possible alternative band carriers if in-band carriers do not have adequate capacity.

### BACKGROUND OF THE INVENTION

1. Technical Field

The present invention relates in mobile wireless digital telephony. More particularly, the present invention relates to mobile wireless digital telephony using code division multiple access (CDMA) techniques.

2. Description of the Related Art

With code division multiple access (CDMA) mobile wireless digital telephony, it has been possible to have several carriers or frequencies available or co-located in one or more cells. The co-located carriers are available in different bands (800 MHZ and 1900 MHZ). When this has occurred a multi-carrier traffic allocation (MCTA) feature available in CDMA mobile wireless digital telephony has been used. Using a carrier determination algorithm (CDA), the MCTA feature selects the best carrier from those that are co-located for incoming calls in the CDMA sectors. U.S. Pat. No. 6,069,871, owned by the assignee of the present application, and of which one of applicants in the present application is a co-inventor, is an example of such a carrier determination algorithm.

There are, however, certain problems with the multi-carrier traffic allocation (MCTA) techniques as they are presently available. Wireless digital telephone service providers who have deployed MCTA in its present form have experienced an increase in failure rates during high access conditions. There are differences in radio frequency coverage among the several carriers co-located in the cells. Because of these differences, access failures have occurred when the CDA selects a different carrier frequency than the one that the mobile originated on.

Attempts have been made with partial success in selected small clusters to optimize radio frequency (RF) coverage and bridge the frequency coverage differences. As a practical matter, however, this technique has been considered difficult to achieve, particularly where network sites have been subject to change or movement for service growth or other factors. Another problem has been that equalization of loading between certain of the carrier frequencies has, so far as is known, not been achievable. Still another problem has been that multi-carrier traffic allocation techniques do not pool together co-located carriers from the different CDMA bands (800 MHZ and 1900 MHZ).

The use of temporary channel assignments followed by a multipilot hard handoff was proposed to solve certain of the foregoing problems. However it was felt that this proposed technique would introduce high rates of handoff failures during multipilot hard handoffs. Further, the handoff failures were undesirable because they were perceived by the mobile telephony users as call drops.

It would be desirable to reduce access failures in mobile wireless digital telephony with multi-carrier traffic allocation. It would also be desirable to provide pooling of co-located carriers in the frequency bands available to code division multiple access mobile wireless digital telephony.

### SUMMARY OF THE INVENTION

Briefly, the present invention enhances multicarrier traffic allocation in mobile wireless digital telephony. The present invention is particularly well-adapted for use in code division multiple access or CDMA mobile wireless digital telephony. The present invention improves the carrier determination algorithm used as a part of the multicarrier traffic allocation (MCTA) feature used to select the best carrier frequency among co-located carriers for call setup for incoming calls to a CDMA sector.

### BRIEF DESCRIPTION OF THE DRAWINGS

FIG. 1 is a schematic diagram of a wireless communication system according to the present invention.

FIG. 2 is a logic diagram illustrating, in general, operation of the wireless communication system in allocating resources among multiple carrier frequencies in setting up and servicing a call to a mobile unit.

FIG. 3 is a schematic diagram of radio frequency coverage of co-located RF carriers in a wireless communication system according to the present invention.

FIG. 4 is a schematic diagram of radio frequency coverage of several cells in partially overlapping sectors of co-located RF carriers in a wireless communication system according to the present invention.

FIG. 5 is another schematic diagram of multi-band radio frequency coverage of several cells in partially overlapping sectors of co-located RF carriers in a wireless communication system according to the present invention.

FIG. 6 is a schematic diagram of another wireless communication system according to the present invention.

FIG. 7 is a schematic diagram illustrating in more detail certain of the components of the wireless communication system of FIG. 6.

FIGS. 8A, 8B, 8C and 8D are message flow diagrams corresponding to the operation of a wireless communication system selecting the originating carrier frequency on a priority allocation basis according to the present invention.

FIGS. 9A, 9B, 9C and 9D are message flow diagrams corresponding to the operation of a wireless communication system selecting a carrier while taking into account carriers in neighboring sectors on a priority allocation basis according to the present invention.

FIGS. 10A, 10B, 10C, 10D and 10E are message flow diagrams corresponding to the operation of a wireless communication system selecting between co-located carrier frequencies on different frequency bands on a priority allocation basis according to the present invention.

### DETAILED DESCRIPTION OF AN ILLUSTRATIVE EMBODIMENT

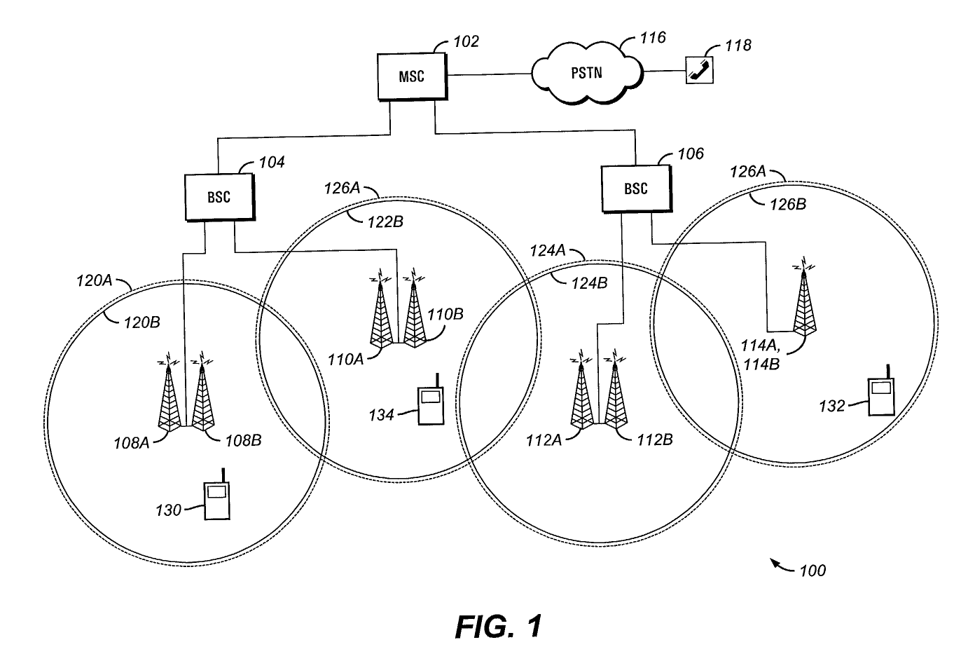

FIG. 1 illustrates a wireless communication system 100 constructed according to the present invention which includes a plurality of cells serviced by multiple carrier frequencies. The present invention is suitable for wireless communication systems operating according to the TIA/EIA/IS95 CDMA standard, or subsequent versions thereof, or the TIA/EIA/IS2000 CDMA standard. In the illustrated embodiment, the wireless communication system 100 operates according to a code division multiple access (CDMA) standard, in particular the TIA/EIA/IS95 CDMA standard, modified as required to accomplish the teachings of the present invention. The wireless communication system 100 uses a carrier determination algorithm (CDA) for multi-carrier traffic allocation, also known as MCTA. The MCTA selects the best carrier from those that are co-located for incoming calls in the CDMA sectors.

U.S. Pat. No. 6,069,871, owned by the assignee of the present application, and of which one of applicants is a co-inventor, is an example of such a carrier determination algorithm for the purposes of multi-carier traffic allocation. The disclosure of such Patent is incorporated herein by reference. The techniques of the present invention described herein may be used in conjunction with the load allocation procedures of that commonly owned patent.

The principles of the present invention also apply to other wireless communication systems operating according to other standards, as well, in which multiple carrier frequencies overlay one another to increase the capacity of the wireless communication system 100.

The wireless communication system 100 includes a mobile switching center (MSC) 102, base station controllers (BSC's) 104 and 106, and a plurality of base stations, each of which includes an antenna and a base station transceiver subsystem (BTS). The MSC 102 couples the wireless communication system 100 to the PSTN 116. The wireless communication system services calls between telephone 118 connected to the PSTN 116, for example, and any of a plurality of mobile units 130, 132 and 134 operating within the wireless communication system. The wireless communication system 100 also services calls among the plurality of mobile units 130, 132 and 134.

BTS's 108A, 108B, 110A and 110B couple to BSC 104 while BTS's 112A, 112B, 114A and 114B couple to BSC 106. The BTS's are constructed such that two carrier frequencies or co-located carriers are supported within the wireless communication system. BTS 108A provides service on a first carrier frequency within cell 120A and BTS 108B provides service on a second carrier frequency within cell 120B, cell 120A substantially overlying cell 120B. Likewise, BTS 110A provides wireless coverage on the first carrier frequency in cell 122A and BTS 110B provides wireless coverage on the second carrier frequency in overlying cell 122B. Further, BTS's 112A and 114A provide wireless coverage on the first carrier frequency in cells 124A and 126A, respectively, and BTS's 112B and 114B provide wireless coverage on the second carrier frequency in overlying cells 124B and 126B, respectively. By providing wireless coverage on the two carrier frequencies, the capacity provided by the wireless communication system 100 is approximately double that which would be available with a single carrier frequency. Each of the cells within the wireless communication system 100 may also be divided into sectors as is generally known. The wireless communication system 100 was originally constructed to provide coverage on a single carrier frequency and then expanded to support a second carrier frequency due to an increase in load growth within the service area. To support operation on the second carrier frequency, additional towers were added to service BTS's 108B, 110B and 112B. However, BTS 114B is serviced by the same tower as BTS 114A, with an antenna added to the existing tower to support BTS 114B. The principles of the present invention apply equally to wireless communication systems constructed originally to support two or more carrier frequencies.

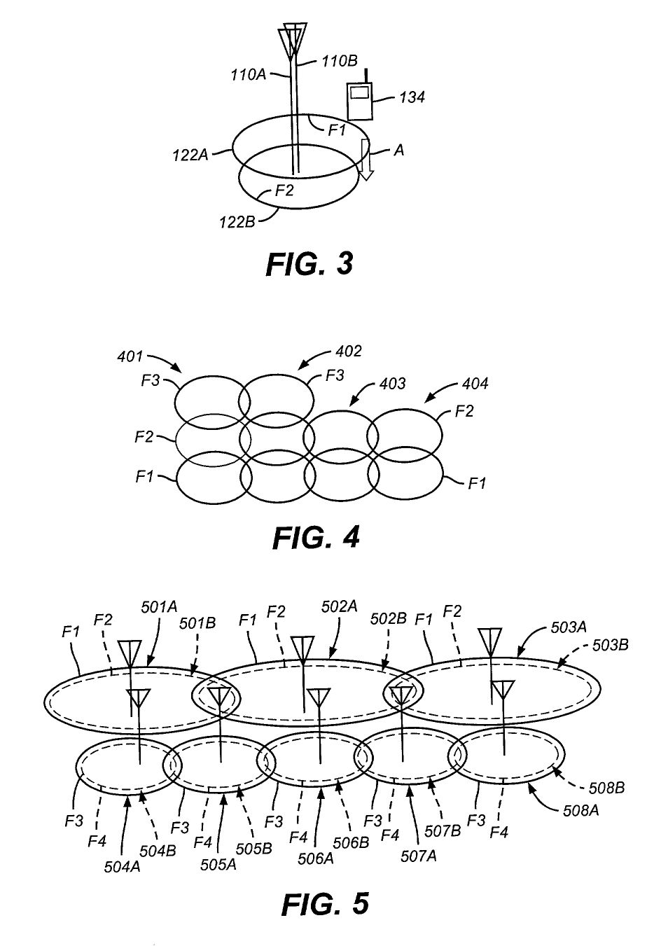

As illustrated in FIG. 3, which shows schematically a portion of the system 100 of FIG. 1, typically the extent of radio frequency (RF) coverage areas for co-located carriers differs. Thus the geographical extent of coverage of, for example, the first frequency F1 in cell 122A is greater than that of the co-located carrier frequency F2 of the overlapping cell 122B, as indicated schematically by an arrow A. Because of this and other factors, access failures have resulted with the carrier determination algorithm (CDA) when a mobile unit accesses the network on a first frequency and is assigned a channel on the second frequency in an attempt to set up a call on the second frequency.

There are certain ways that the frequency problem of coverage differences between co-located carrier frequencies can be somewhat reduced. In systems compliant with the industry IS-95B mobile standard or subsequent versions, channel assignment into an up to six-way soft handoff is supported. However, the existing carrier determination algorithm does not, so far as is known, consider availability for carriers in neighboring sectors, even though those carriers have and report adequate signal strength.

In an example of an operation of the wireless communication system 100 (FIG. 1), mobile unit 130 initiates a call within cell 120A or 120B which is intended for a destination telephone 118 coupled to the PSTN 116. Assuming that the mobile unit 130 responds on a control channel of the first carrier frequency, the mobile unit 130 contacts BTS 108A, seeking to initiate the call. BTS 108A then sends an origination message via the BSC 104 to the MSC 102. The MSC 102 then requests the BSC 104 to allocate resources to service the call and commences to complete the call via the PSTN 116 to destination 118. The BSC 104 then sends capacity requests to each BTS that may service the call within the wireless communication system 100, e.g. BTS's 108A and 108B serving cells 120A and 120B. The BTS's 108A and 108B respond with capacity indications and, based upon the capacity indications, the BSC 104 selects BTS 108B to service the call on the second carrier frequency. The call is then completed via BTS 108B, BSC 104, MSC 102 and the PSTN 116. Of course, in another operation, the BSC 104 could select BTS 108A to service the call on the first carrier based upon differing capacity indications. In another operation of the wireless communication system 100 a call originates from telephone 118 and is sought to be delivered to mobile unit 132. When the telephone 118 contacts the MSC 102 via the PSTN 116, the MSC 102 initiates a page to the mobile unit 132 according to paging operations for the wireless communication system 100. The mobile unit 132 then responds to the page via BTS 114A, for example. The BTS 114A responds to the MSC 102 via the BSC 106 and interacts with BSC 106 to set up the call. In response, the BSC 106 queries BTS's 114A and 114B for capacity information. Based upon the responses received from BTS's 114A and 114B, the BSC 106 assigns a traffic channel on the first carrier frequency, serviced by BTS 114A and corresponding to cell 126A. The call is then completed via BTS 114A, BSC 106, MSC 102 and the PSTN 116. Of course, in another operation based upon differing capacity indications, the BSC 106 could assign a traffic channel on the second carrier frequency serviced by BTS 114B within cell 126B.

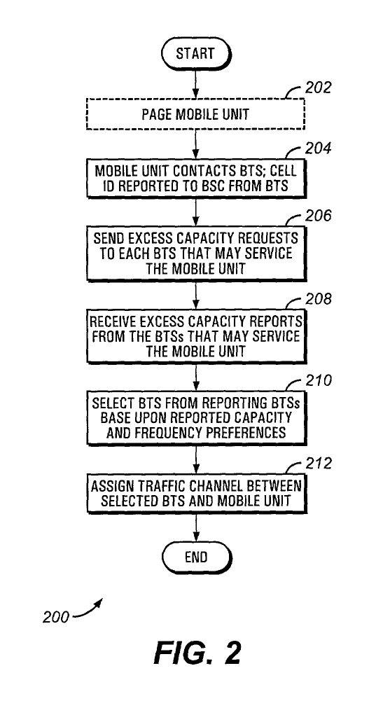

FIG. 2 illustrates an operation sequence 200 of a wireless communication system according to the present invention in allocating resources on their respective carrier frequencies upon initiation of a call. Operation commences at optional step 202 where a mobile unit is paged by the wireless communication system. When the mobile unit requests to establish a call, no page is sent to the mobile unit and step 202 is not performed. At step 204, the mobile unit communicates with the wireless communication system, either in response to the page sent at step 202 or when attempting to establish the call. The BTS communicating with the mobile unit then contacts its serving BSC, sending its cell ID to the BSC. The BSC relays this information to the MSC. In one embodiment of the present invention, control channels are supported only on one carrier frequency of the multiple carrier frequencies supported across the wireless communication system. In other embodiments, control channels are supported on more than one carrier frequency. Depending upon the embodiment, and the operations supported by the mobile unit, the mobile unit contacts a BTS on a carrier frequency that supports a control channel. Next, at step 206, the MSC serving the BSC directs the BSC to allocate resources to service the call. In response, the BSC determines candidate BTS's to service the call and seeks capacity information from each candidate BTS's. At step 208, the BSC receives the excess capacity reports from the candidate BTS's that respond. While it is desired that each candidate BTS respond to indicate its excess capacity, some of the candidate BTS's may not respond. With the reported excess capacity information received, at step 210, the BSC selects at least one BTS from those reporting based upon the reported excess capacities and frequency preferences for the particular operation. As was previously described, multiple BTS's may serve a common area on differing carrier frequencies. Thus, a particular carrier frequency is resultantly selected at step 210. After the selection is made, operation proceeds to step 212 wherein a traffic channel serviced by the selected BTS(s) on the selected carrier frequency is assigned and the call is serviced until it is complete. FIG. 4 illustrates another problem encountered. There are several cells comparable in structure to those shown in FIG. 1 in partially overlapping sectors, including carrier frequencies F1, F2 and F3 in a first cell 401 and a border cell 402 between the first cell 401 and other cells 403 and 404. The cells 403 and 404 support only two of the co-located frequencies, F1 and F2, of those supported by the first cell 401 and the border cell 402. A mobile user assigned a channel with frequency F3 and in transit from cell 402 into cell 403 is the subject of a needless hard handoff on transition from the border cell 402 to the cell 403.

FIG. 5 illustrates another problem situation with co-located carrier frequencies belonging to two different CDMA frequency bands. The carriers shown in FIG. 5 are in cells of comparable structure to those shown in FIG. 1. Cells 501A, 501B, 502A, 502B, 503A, and 503B have co-located carrier frequencies F1 and F2 in one CDMA frequency band (800 MHz). Also co-located are cells 504A, 504B, 505A, 505B, 506A, 506B, 507A, 507B, 508A, and 508B which have co-located carrier frequencies F3 and F4 in the alternate CDMA frequency band (1900 MHz). The Radio Frequency (RF) coverage of cells operating in the 800 MHz frequency band can possess 3-to-1 overlay as compared to the RF coverage of cells operating in the 1900 MHz frequency band. That is, the RF coverage of one CDMA cell operating in the 800 MHz frequency band, such as 502A, may span the RF coverage of three CDMA cells operating in the 1900 MHz frequency band, such as 505A, 506A, and 507A. So far as is known, however, the present carrier determination algorithm does not support allocation of traffic between the two different CDMA frequency bands.

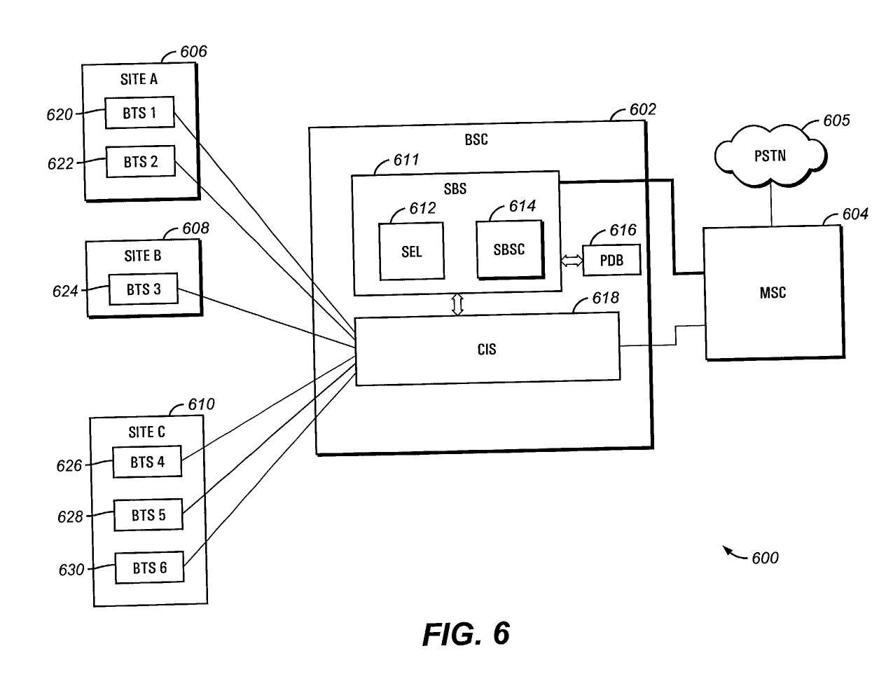

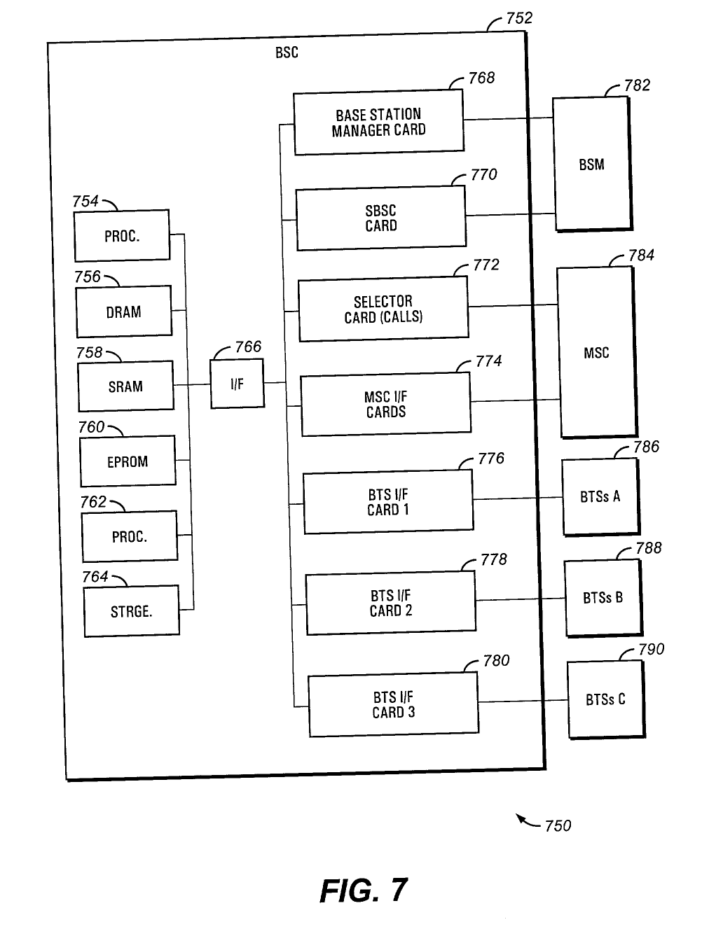

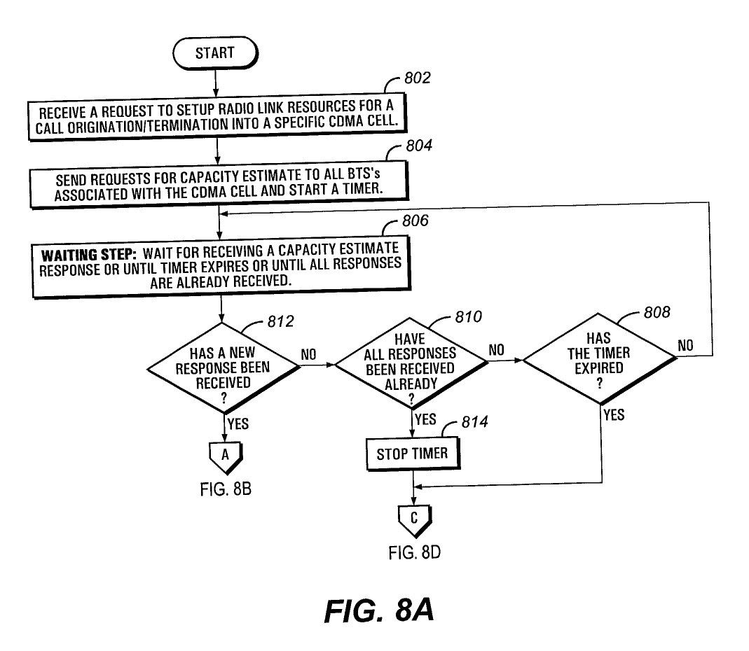

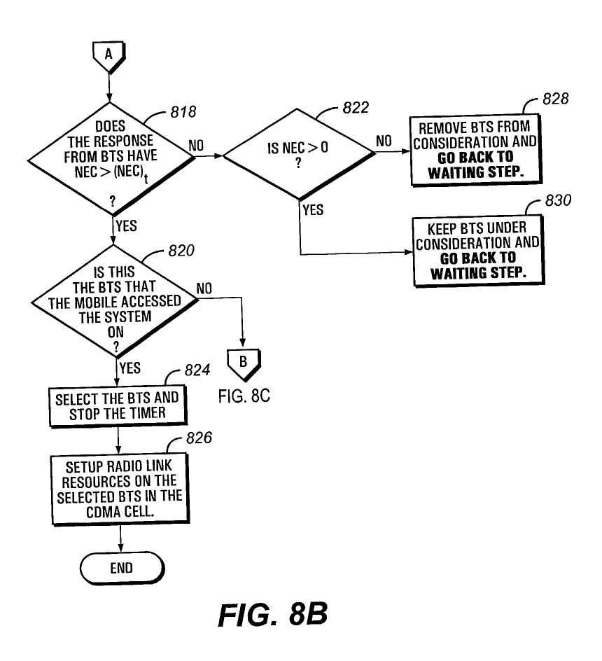

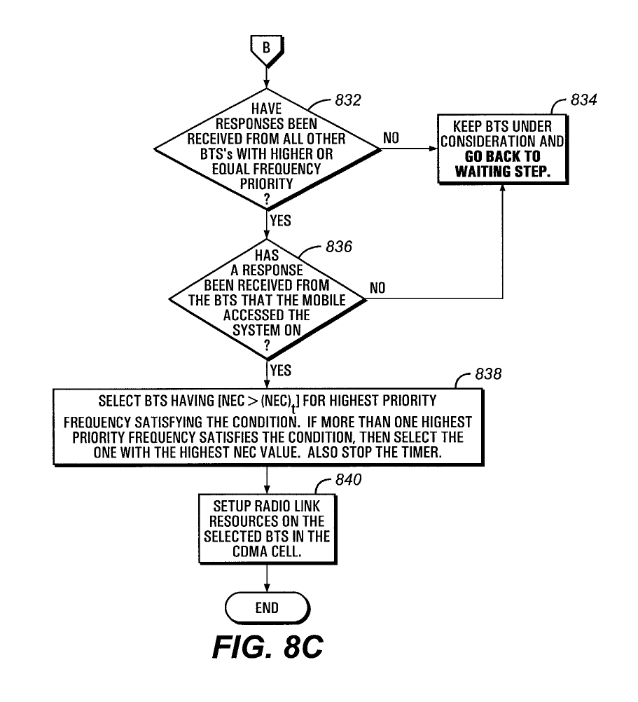

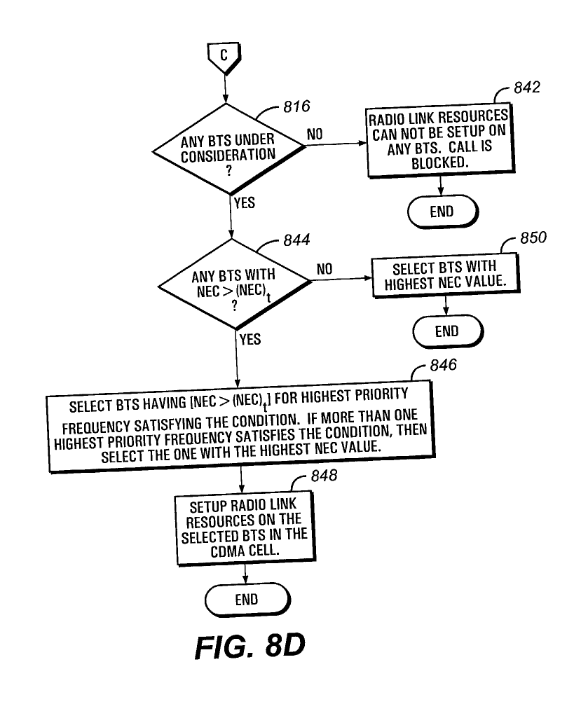

FIG. 6 illustrates components of wireless communication system 600 constructed according to the present invention. Illustrated are a BSC 602, an MSC 604 coupled to the PSTN 605 and a plurality of BTS sites 606, 608 and 610. BTS site A 606 includes BTS 1 620 which supports a first carrier frequency and BTS 2 622 which supports a second carrier frequency. BTS site B 608 includes BTS 3 624 which supports only the first carrier frequency. BTS site C 610 includes 3 BTS's, BTS 4 626 which supports the first carrier frequency, BTS 5 628 which supports the second carrier frequency and BTS 6 630 which supports a third carrier frequency. In a typical installation, other BTS sites couple to the BSC 602 as well to provide coverage throughout a service area. The BSC 602 includes a selector bank subsystem (SBS) 611, a pilot data base (PDB) 616 and a CDMA interconnect system (CIS) 618. The SBS 611 includes a selector bank (SEL) 612 and a SBS controller (SBSC) 614. The SBS 611 as well as the CIS 618 couple to the MSC 604. Further, the CIS 618 couples to the BTS's 620 through 630 contained at the various sites and the SBS 611. The SBS 611 couples to the PDB 616 and controls the SEL 612 to provide communication, in conjunction with the CIS 618, between the MSC 604 and the BTS's 620-630. The SBSC 614 operates to perform multiple carrier frequency allocation according to the present invention to allocate resources in servicing calls on the various carrier frequencies supported by the wireless communication system. The PDB 616 contains pre-loaded therein a net excess capacity threshold NECₜ for each BTS in the system. The use of this measure is discussed in subsequent portions of the present disclosure. FIG. 7 illustrates an alternate construction of components of a wireless communication system 750 according to the present invention, with particular description of a BSC 752. The BSC 752 couples to a base station manager 782, a mobile switching center 784 and BTS's group A 786, group B 788 and group C 790, each of which includes a plurality of BTS's. The BSC 752 includes a base station manager card 768 and an SBSC card 770, both of which couple to the base station manager 782. A selector card 772 and an MSC interface card 774 couple to the MSC 784. BTS interface card 1 776 couples to BTS group A 786, BTS interface card 2 778 couples to BTS group B 788 and BTS interface card 3 780 couples to BTS group C 790. The cards 768 through 780 allow the BSC 752 to perform the operations consistent with the present invention in initially allocating resources and in performing dynamic load balancing in the multiple carrier frequency system. The BSC 752 also includes a processor 754, dynamic RAM 756, static RAM 758, EPROM 760, and bulk storage that couple to the cards 768 through 780 via interface 766. Such components perform overall management of the BSC 752. Operations of the present invention are accomplished by these components and the interface cards 768-780 contained in the BSC 752. As is generally known in the art, electronic processing equipment, such as the processor 754 and components of the interface cards 768-780 contained within the BSC 752 may be programmed to perform specific operations. The electronic processing equipment may be constructed specifically to accomplish operations consistent with the present invention or may be generally constructed, and then programmed specifically to perform operations according to the present invention. FIGS. 8A, 8B, 8C and 8D illustrate in greater detail allocation of resources of a wireless communication system constructed according to the present invention upon call initiation, with particular applicability to CDMA operation where a BTS represents only one carrier frequency. The present invention can also be practiced with BTS's which have more than one carrier frequency. The operations illustrated in FIGS. 8A, 8B, 8C and 8D are adapted for wireless communication systems with coverage such as that shown, for example, schematically in FIG. 4. The operations of FIGS. 8A, 8B, 8C and 8D show selection of the originating carrier frequency of available multiple carrier frequencies when there is available capacity on that originating carrier frequency. The operations shown in these figures also take into consideration carriers assigned the same priority when the originating carrier frequency does not have adequate capacity.

Referring first to FIG. 8A, operation commences at step 802 wherein a BSC has received a request for radio link resources from an MSC for a specific CDMA cell. Such request is sent by the MSC in attempting to complete a call that was either initiated by a mobile unit or that is to be terminated to a mobile unit. Then, at step 804, the BSC serving the specific CDMA cell sends capacity estimate requests to all BTS's associated with the cell and starts a timer.

The queried BTS's determine and provide their respective net excess capacity NEC to the BSC. The queried BTS's may also optionally provide a stored net excess capacity threshold NECₜ, if desired. A suitable method for determining NEC is set forth, for example, in commonly owned U.S. Pat. No. 6,069,871, previously referenced which is incorporated herein by reference.

According to the techniques of that U.S. patent, each of the BTS's that has been queried provides its NEC and, if desired, NECₜ to the BSC. In a desired operation, each of the queried BTS's responds to the BSC with the requested information.

Operation then moves to step 806 wherein the BTS waits for responses to the capacity estimates. Waiting during step 806 lasts until any one of three events, shown in steps 808, 810 and 812 should occur. If the timer started during step 804 expires as indicated at step 808, operation moves to step 816 (FIG. 8D). If all responses have been received as indicated at step 810, the timer is stopped at step 814 and operation also moves to step 816. Finally, if a response is received as indicated at step 812, operation moves via an off page connector to step 818 (FIG. 8B).

At step 818, each response received from a BTS is evaluated to determine whether the net excess capacity NEC exceeds the net excess capacity threshold NECₜ. If such is the case, operations proceed to step 820. If not, operations proceed to step 822.

During step 820, a determination is made whether the responding BTS is the one that the mobile unit accessed the system on. If so, during step 824 that BTS is selected and the timer started during step 804 is stopped. The requested radio link resources are then set up during step 826 and the procedure ended.

During step 822, a determination is made whether the net excess capacity NEC for the responding BTS is greater than zero. If not, that responding BTS is removed from consideration in step 828 and operations return to step 806 and continue in the manner described. If step 822 results in an affirmative response, the responding BTS is kept under consideration during step 830 and operations return to step 806 and continue in the manner described. Referring now to FIG. 8C, operation proceeds from step 820 to step 832 where a determination is made whether responses have been received from all BTS's with a higher or equal priority in the storage of the PDB's. If not, the responding BTS is kept under consideration during step 834 and operations return to step 806 and continue in the manner described.

If the result of step 832 is affirmative, operations proceed to step 836 where a determination is made whether a response has been received from the BTS on which the mobile unit accessed the wireless system. If not, operations return to step 834 and proceed in the manner already described.

If step 836 results in an affirmative response, operations proceed to step 838. During step 838 the BTS having a net excess capacity greater than the net excess capacity threshold is selected for the highest priority frequency where that condition is met. If more than one BTS meets these criteria, the BTS with the highest net excess capacity is selected, the timer started during step 804 is stopped and operations proceed to step 840. During step 840, the requested radio link resources are then set up on the selected BTS during step 826 and the procedure ended.

Step 816 (FIG. 8D) occurs after step 814 (FIG. 8A) and determines whether any BTS remains under consideration. If not, operations proceed to step 842 where operations end because radio link resources can not be set up for any BTS. The call is blocked.

If step 816 results in an affirmative response, operations proceed to step 844, where a determination is made whether there is any responding BTS where the net excess capacity exceeds the net excess capacity threshold NEC_{t.} If so, operations proceed to step 846 where the BTS having a net excess capacity greater than the net excess capacity threshold is selected for the highest priority frequency where that condition is met. If more than one carrier frequency meets this condition, the carrier with the highest net excess capacity is selected. Operations proceed to step 848 where the requested radio link resources are then set up on the selected BTS and the procedure ended.

If the result of step 846 is negative, during step 850 the BTS responding with the highest net excess capacity is selected and operations continue to step 848 for processing in the manner already described.

The operations according to the present invention illustrated in FIGS. 8A, 8B, 8C and 8D thus select the originating carrier frequency when there is available capacity on that carrier frequency.

Further, where the originating carrier frequency does not have adequate capacity, the operations in FIGS. 8A, 8B, 8C and 8D offer further procedures. When only one carrier has the highest priority, the algorithm waits for a capacity estimate is received for that carrier or until the timeout period set for the timer during step 804 expires. That carrier frequency is then selected if a relative capacity estimate, defined as the net excess capacity minus the net excess capacity threshold, is positive for that carrier.

When more than one carrier is assigned with equal high priority, the procedure of the present invention waits for a capacity estimate response from each of the high priority carriers, or until the time set for the timer during step 804 expires. The algorithm then selects the carrier from among them which indicates the highest relative capacity estimate, as defined above.

Should either a capacity response not arrive from the carrier with the highest priority or the relative capacity estimate for these carriers be negative, the next highest priority then becomes the highest priority. The procedure continues in this manner without, however, restarting the timer. Should none of the co-located carriers indicate a positive relative capacity estimate, the carrier with the highest capacity estimate is then chosen.

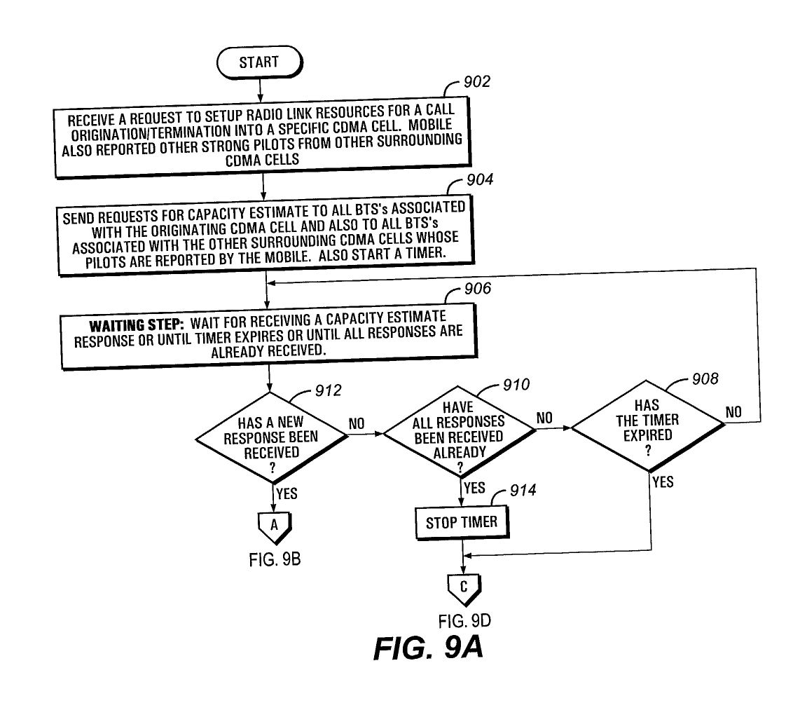

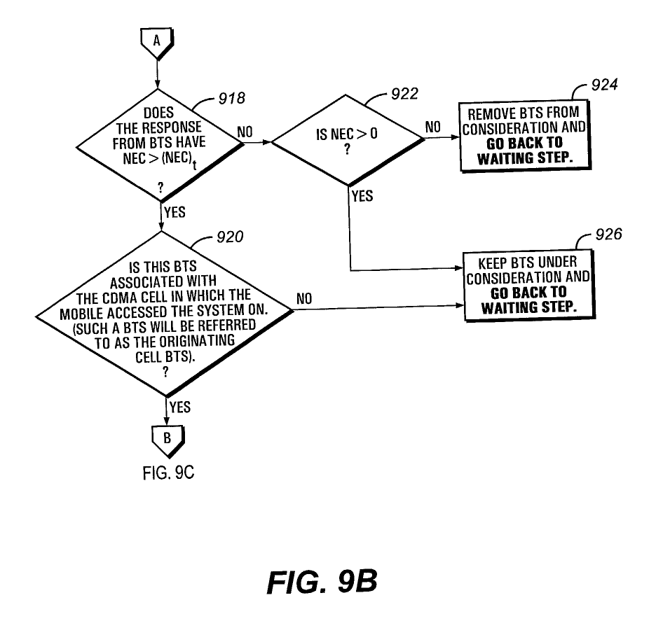

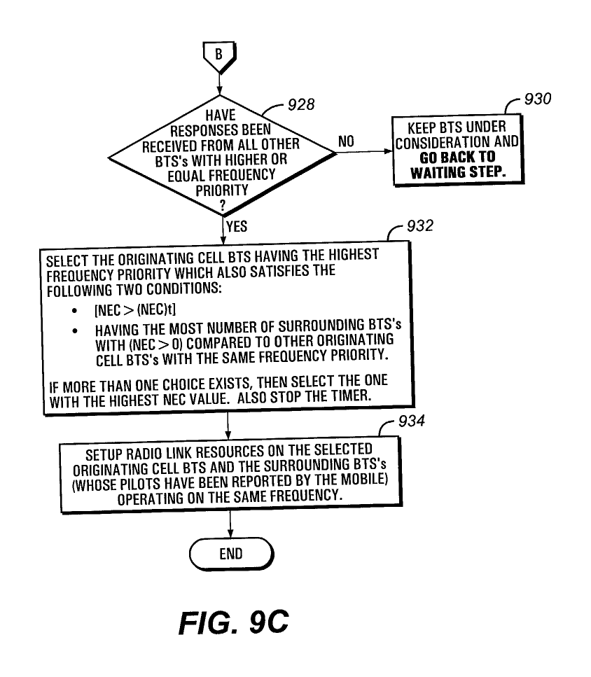

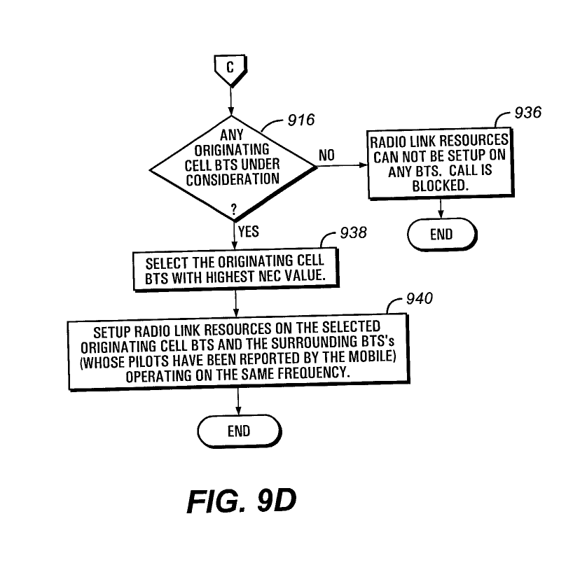

FIGS. 9A, 9B, 9C and 9D illustrate in greater detail assignment of resources of a wireless communication system constructed according to the present invention upon call initiation, again with particular applicability to CDMA operation where a BTS represents only one carrier frequency. The present invention can, as mentioned, also be practiced with BTS's which have more than one carrier frequency. FIGS. 9A, 9B, 9C and 9D depict operations in connection with mobile units which are compliant with the CDMA IS/95B standard and subsequent versions or the CDMA IS/2000 standard in coverage like that shown schematically in FIG. 5. The operations illustrated in FIGS. 9A, 9B, 9C and 9D show operation of a wireless system in connection with termination/origination of calls involving that type of mobile units which support up to six-way soft handoff. In the operation according to FIGS. 9A, 9B, 9C and 9D resource availability on neighboring sectors to a reference sector is considered where the pilots were reported by those mobile units during the originations or terminations. Consideration is also given to assignment of calls onto carriers assigned with the same priority during operations according to FIGS. 9A, 9B, 9C and 9D.

Referring first to FIG. 9A, operation commences at step 902 wherein a BSC has received a request for radio link resources from an MSC for a specific CDMA cell. That request is from a mobile unit compliant with the CDMA 95B or later version standard and thus reports the presence of any other strong pilot signals from CDMA cells in surrounding sectors as shown in FIG. 1. Such request is sent by the MSC in attempting to complete a call that was either initiated by such a mobile unit or that is to be terminated to such a mobile unit. Then, at step 904, the BSC serving the specific CDMA cell sends capacity estimate requests to all BTS's associated with the originating cell and the other cells whose pilots have been reported by the mobile unit. In addition, a timer is started during step 904.

The queried BTS's determine and provide their respective net excess capacity NEC to the BSC. The queried BTS's may also optionally provide a stored net excess capacity threshold NECₜ, if desired. As has been set forth above, the techniques of commonly owned U.S. Pat. No. 6,069,871, previously referenced, can be used for this purpose.

According to the techniques of that U.S. patent, each of the BTS's that has been queried provides its NEC and, if desired, its NECₜ to the BSC. In a desired operation, each of the queried BTS's responds to the BSC with the requested information. Operation then moves to step 906 wherein the BSC waits for responses to the capacity estimates. Waiting during step 906 lasts until any one of three events, shown in steps 908, 910 and 912 should occur. If the timer started during step 904 expires as indicated at step 908, operation moves to step 916 (FIG. 9D). If all responses have been received as indicated at step 910, the timer is stopped at step 914 and operation also moves to step 916. Finally, if a response is received as indicate at step 912, operation moves via an off page connector to step 918 (FIG. 9B).

At step 918, each response received from a BTS is evaluated to determine whether the net excess capacity NEC exceeds the net excess capacity threshold NECₜ. If such is the case, operations proceed to step 920. If not, operations proceed to step 922.

During step 920, a determination is made whether the responding BTS is associated with the CDMA cell in which the mobile accessed the wireless system. Hereinafter such a cell is referred to as an originating cell and such a BTS is referred to as an originating cell BTS. If step 920 results in an affirmative determination, operations proceed to step 928 (FIG. 9C). If during step 920 the determination is negative, operations proceed to step 926, where the responding BTS is kept under consideration during step 926 and operations return to step 906 and continue in the manner described.

During step 922, a determination is made whether the net excess capacity NEC for the responding BTS is greater than zero. If not, that responding BTS is removed from consideration in step 924 and operations return to step 906 and continue in the manner described. If step 922 results in an affirmative response, the responding BTS is again kept under consideration during step 926 and operations return to step 906 and continue in the manner described. Referring now to FIG. 9C, operation proceeds to step 928 from step 920. During step 928 a determination is made whether responses have been received from all BTS's with a higher or equal assigned priority indicated in storage of their PDB's. If not, the responding BTS is kept under consideration during step 930 and operations return to step 906 and continue in the manner described.

If the result of step 928 is affirmative, operations proceed to step 932 where a selection procedure is performed. The BTS which has the highest frequency priority and which also satisfies two additional conditions is selected. Those two additional conditions are: first, that one net excess capacity NEC must exceed the net excess capacity threshold NECₜ; and, second: that the BTS must have the greatest number of surrounding BTS's with a non-zero net excess capacity in comparison with other originating cell BTS's. Should there be more than one choice, the BTS with the highest net excess capacity is chosen. The timer started during step 904 is also stopped during step 932 and operations proceed to step 934.

During step 934, the requested radio link resources are then set up on the selected originating cell BTS and on those surrounding BTS's operating on the same frequency whose pilots have been reported by the mobile unit and the procedure ended.

Step 916 (FIG. 9D) occurs after step 914 (FIG. 9A) and determines whether any BTS remains under consideration. If not, operations proceed to step 936 where operations end because radio link resources can not be set up on any BTS. The call is blocked.

If step 916 results in an affirmative response, operations proceed to step 938, where the originating cell BTS with the highest net excess capacity is selected. Operations proceed to step 940 where the requested radio link resources are then set up on the selected originating cell BTS and on those surrounding BTS's operating on the same frequency whose pilots have been reported by the mobile unit and the procedure ended.

The operations according to the present invention illustrated in FIGS. 9A, 9B, 9C and 9D thus select channel allocations for CDMA IS/95B and subsequent version compliant mobile stations in a manner which takes advantage of channel assignment into soft handoff. This is done by considering resource availability for carrier frequencies in neighboring sectors whose pilots are reported by the mobile due to their strength. The originating cell BTS is chosen according to the conditions set forth in step 932. When more than one originating cell BTS is assigned equal high priority, the procedure of the present invention selects the originating cell BTS carrier from among those which had the highest relative capacity estimate.

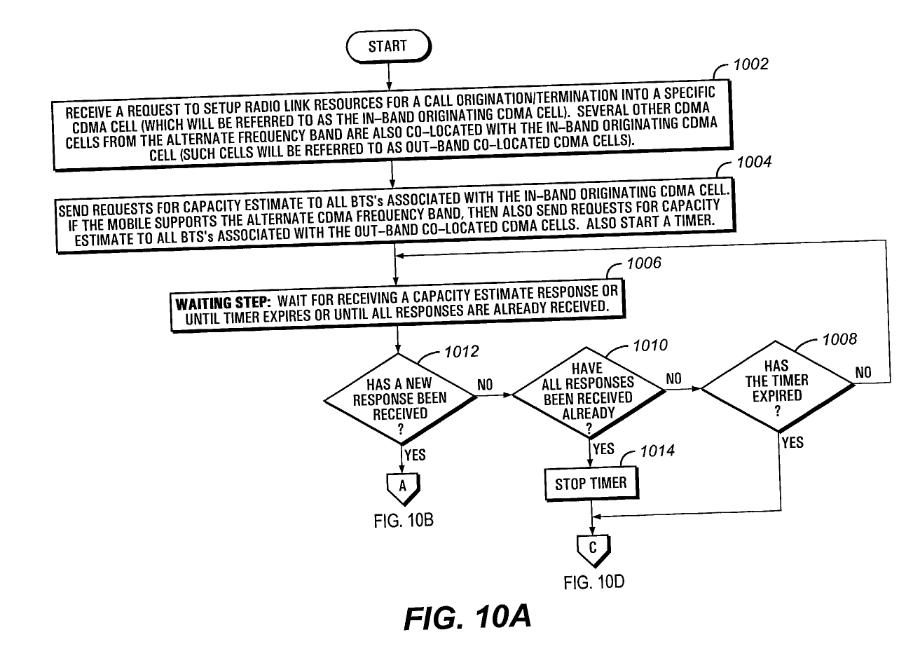

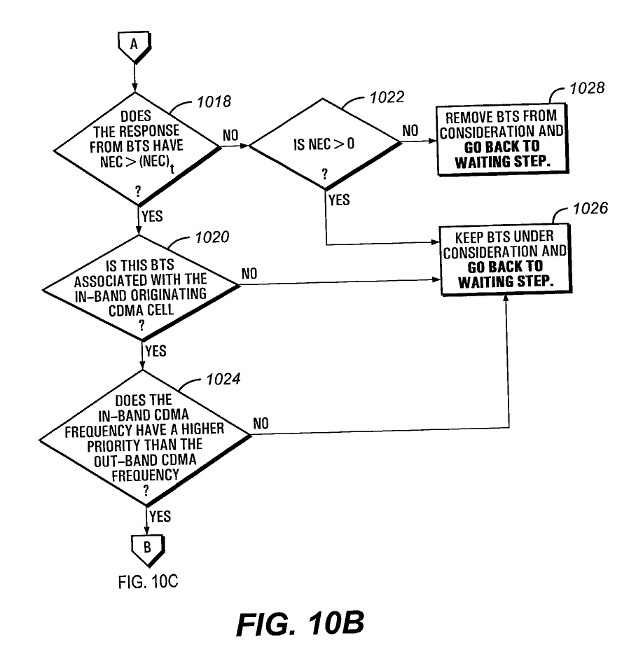

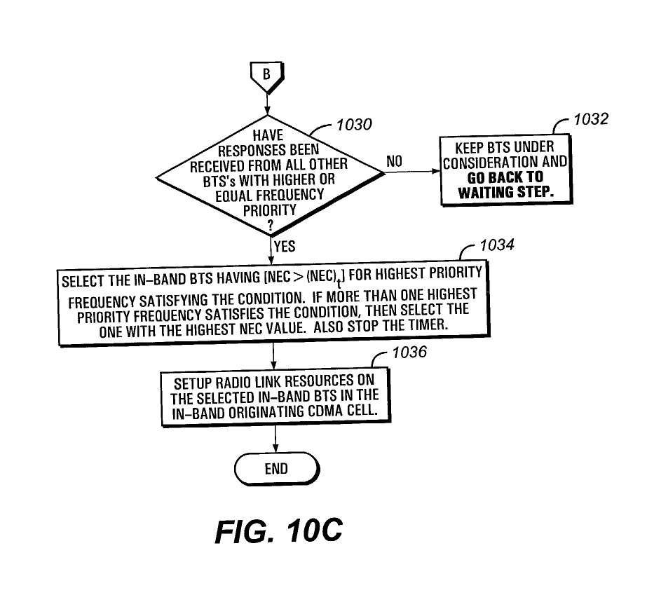

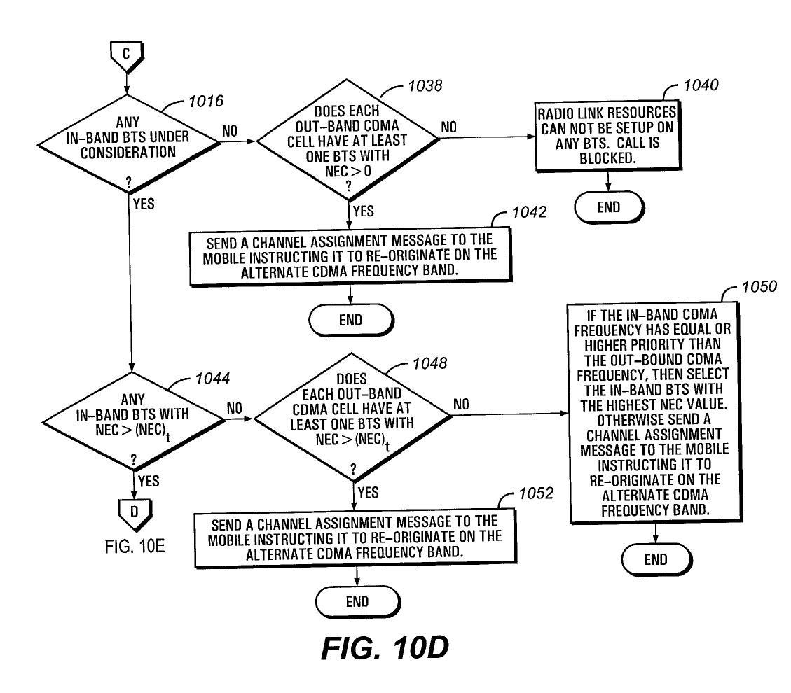

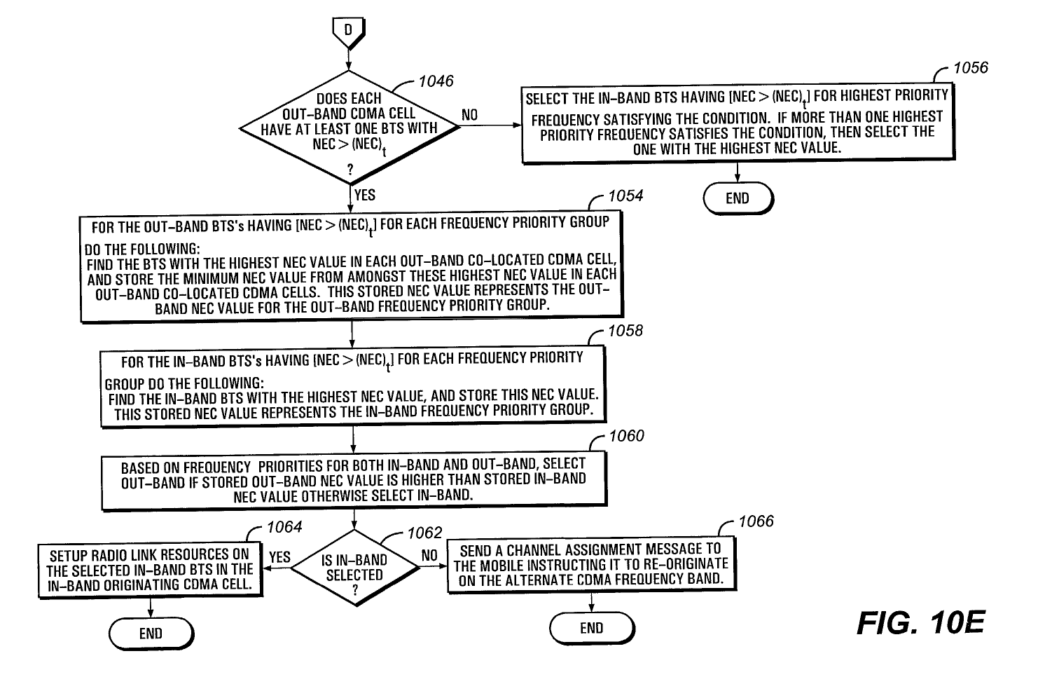

FIGS. 10A, 10B, 10C, 10D and 10E illustrate in greater detail allocation of resources of a wireless communication system constructed according to the present invention upon call initiation, with particular applicability to CDMA where a BTS represents only one carrier frequency. The present invention can, as has been noted also be practiced with BTS's which have more than one carrier frequency. The operations illustrated in FIGS. 10A, 10B, 10C, 10D and 10E are adapted for a communication system of the type shown schematically in FIG. 6, and where call attempts are made by mobiles that support both frequency bands illustrated there.

In the discussion which follows, a cell in which the mobile originates or terminates a call is referred to as an in-band originating cell. Those cells co-located with the in-band originating cell but operating on a different frequency band are referred to as out-band co-located CDMA cells. These co-located cells are identified in the PDB for the in-band BTS's.

The operations illustrated in FIGS. 10A, 10B, 10C, 10D and 10E show selection of a carrier frequency after sending capacity estimate requests to the BTS's in the originating in-band cell and to BTS's in the co-located out-band CDMA cells. In this way, the present invention selects a best alternate band carrier for call setup when the in-band carriers do not have adequate capacity for the call setup. The operations shown in these figures also take into consideration carriers assigned with the same priority.

Referring first to FIG. 10A, operation commences at step 1002 wherein a BSC has received a request for radio link resources from an MSC into a specific CDMA cell. The request received during step 1002 is sent by the MSC in attempting to complete a call that was either initiated by a mobile unit or that is to be terminated to a mobile unit. Then, at step 1004, the BSC serving the specific CDMA cell sends capacity estimate requests to all BTS's associated with the in-band originating CDMA cell. If the mobile also supports the alternate CDMA frequency band, capacity estimate requests are also sent to BTS's associated with the out-band co-located CDMA cells. Step 1004 also starts a timer.

The queried BTS's determine and provide their respective net excess capacity NEC to the BSC. Again, if desired, the queried BTS's may also provide a stored net excess capacity threshold NECₜ, which can be determined, using, for example, the techniques of commonly owned U.S. Pat. No. 6,069,871, previously referenced.

According to the techniques of that U.S. patent, each of the BTS's that has been queried may provide its NEC and, if desired, NECₜ to the BSC. In a desired operation, each of the queried BTS's responds to the BSC with the requested information. Operation then moves to step 1006 wherein the BTS waits for responses to the capacity estimates. Waiting during step 1006 lasts until any one of three events, shown in steps 1008, 1010 and 1012 should occur.

If the timer started during step 1004 expires as indicated at step 1008, operation moves to step 1016 (FIG. 10D). If all responses have been received as indicated at step 1010, the timer is stopped at step 1014 and operation also moves to step 1016. Finally, if a response is received as indicated at step 1012, operation moves via an off page connector to step 1018 (FIG. 10B).

At step 1018, each response received from a BTS is evaluated to determine whether the net excess capacity NEC exceeds the net excess capacity threshold NECₜ. If such is the case, operations proceed to step 1020. If not, operations proceed to step 1022.

During step 1020, a determination is made whether the responding BTS is associated with the in-band originating CDMA cell. If so, operations proceed to step 1024. During step 1024, a determination is made whether the in-band CDMA frequency has a higher priority than the out-band CDMA frequency. If the result is affirmative, operations proceed to step 1030 (FIG. 10C). If the results of step 1020 are negative, operations proceed to step 1026.

During step 1022, a determination is made whether the net excess capacity NEC for the responding BTS is greater than zero. If not, that responding BTS is removed from consideration in step 1028 and operations return to step 1006 and continue in the manner described.

If step 1022 results in an affirmative response, the responding BTS is kept under consideration during step 1026 and operations return to step 1006 and continue in the manner described. Step 1026 is also performed in the event the results of either of steps 1020 or 1024 are negative.

Referring now to FIG. 10C, operation proceeds from step 1024 to step 1030 where a determination is made whether responses have been received from all in-band BTS's with a higher or equal assigned priority. If not, the responding BTS is kept under consideration during step 1032 and operations return to step 1006 and continue in the manner described.

If the result of step 1030 is affirmative, operations proceed to step 1034 where the in-band BTS which has a net excess capacity NEC which exceeds the net excess capacity threshold NECₜ for the highest priority frequency satisfying the condition is selected. If more than one highest priority frequency satisfies the condition, the one with the highest NEC value is selected. The timer started during step 1004 is stopped and operations proceed to step 1036. During step 1036, the requested radio link resources are then set up and the procedure ended.

Step 1016 (FIG. 10D) occurs after step 1014 (FIG. 10A) and determines whether any in-band BTS remains under consideration. If not, operations proceed to step 1038 where a determination is made whether each out-band CDMA cell has at least one BTS with an NEC greater than zero. If not, operations proceed to step 1040 where the procedure ends because the call is blocked.

If the result of step 1038 is a positive determination, operations proceed to a step 1042. During step 1042 a channel assignment message is sent to the mobile station instructing the mobile station to re-originate on the alternate CDMA frequency band. As an alternative for mobiles compliant with CDMA IS/95B and subsequent versions, resources could be set up on the co-located out-band CDMA cells. After step 1042, the procedure then ends.

If step 1016 results in an affirmative response, operations proceed to step 1044, where a determination is made whether there is any responding BTS where the net excess capacity exceeds the net excess capacity threshold NECₜ. If so, operations proceed to step 1046 (FIG. 10E). If not, operations proceed to step 1048 where a determination is made whether each of the out-band CDMA cells has at least one BTS with a net excess capacity NEC exceeding the net excess capacity threshold.

If the results of step 1048 is a negative determination, operations proceed to a step 1050. During step 1050, the priority of in-band CDMA frequency is compared to that of the out-band CDMA frequency. If the in-band frequency was of equal or higher priority, the in-band BTS with the highest NEC value is selected. If the in-band frequency has lower priority, a channel assignment message is sent to the mobile station. The message instructs the mobile station to re-originate on the alternate frequency band. Again, as an alternative for mobiles compliant with CDMA IS/95B and subsequent versions, resources could be set up on the co-located out-band CDMA cells. The procedure then ends.

If the result of step 1048 is a positive determination, a channel assignment message is sent to the mobile station. The message instructs the mobile station to re-originate on the alternate frequency band. Once again as an alternative for mobiles compliant with CDMA IS/95B and subsequent versions, resources could be set up on the co-located out-band CDMA cells. The procedure then ends until the mobile station sends a request, re-starting the process.

During step 1046 (FIG. 10E), a determination is made whether each out-band CDMA cell has at least one BTS with a net excess capacity greater than the net excess capacity threshold. If so, operations proceed to step 1054. If not, operations proceed to step 1056.

During step 1056, the in-band BTS with the highest priority frequency which satisfies that excess capacity condition is selected. If there is more than one BTS with the highest priority satisfying the condition, the BTS among them having the highest value of a net excess capacity is chosen and the allocation process then ended.

During step 1054, for those out-band BTS's having a net excess capacity greater than the net excess capacity threshold, the following sequence is performed for each frequency priority group. The BTS with the highest NEC in each out-band co-located CDMA cell is determined and stored. In addition, the minimum NEC value among the stored values is also determined and stored. This stored minimum NEC value is selected as the out-band NEC value for the out-band frequency priority group.

Operations proceed to step 1058, where for the in-band BTS's the highest NEC value for the in-band frequency priority group is determined and stored. This stored NEC value is selected as the in-band NEC value for the in-band frequency priority group.

Operations proceed to step 1060. Based on frequency priorities, the stored NEC values are evaluated for both in-band and out-band. If the stored NEC value for the out-band frequency group is higher, the out-band frequency is selected. If not, the in-band frequency is selected.

Operations then proceed to step 1062, where a determination is made whether or not the in-band frequency is selected. If step 1062 determines that an in-band frequency group has been selected, operations proceed to step 1064. During step 1064, the requested radio link resources are then set up on the selected BTS and the procedure ended.

If step 1062 determines that an in-band frequency has not been selected, operations proceed to step 1066. During step 1066, a channel assignment message is sent to the mobile station instructing the mobile station to re-originate on the alternate CDMA frequency band. As an alternative for mobiles compliant with CDMA IS/95B and subsequent versions, resources could be set up on the co-located out-band CDMA cells. The procedure then ends.

The operations according to the present invention illustrated in FIGS. 10A, 10B, 10C, 10D and 10E thus query alternate bands in the datafilled sectors to select an optimum alternate band carrier for call setup for mobiles that support the two bands of CDMA when all in-band carriers in the reference sector do not have adequate capacity left for the call set-up. When more than one carrier is assigned with equal high priority, the procedure of the present invention waits until the time set for the timer during step 1006 to receive a capacity estimate response for each of the high priority carriers, and then selects the carrier from among them which indicates the highest relative capacity estimate.

Should either a capacity response not arrive from the carrier with the highest priority or the relative capacity estimate for these carriers be negative, the next highest priority then becomes the highest priority. The procedure continues in this manner, without, however restarting the timer.

In view of the above detailed description of the present invention and associated drawings, other modifications and variations will now become apparent to those skilled in the art. It should also be apparent that such other modifications and variations may be effected without departing from the spirit and scope of the present invention as set forth in the claims which follow.

What is claimed is:

1. A wireless communication system that provides wireless service to a mobile unit operating on one of a first carrier frequency and a second carrier frequency within a service area, the first and second carrier frequencies being in the same or different bands, the wireless communication system comprising:
at least one base station controller, the at least one base station controller producing a capacity request in response to a request made by the mobile unit on an originating carrier frequency of the first and second carrier frequencies; a first plurality of base stations coupled to the at least one base station controller, the first plurality of base stations operating on a first carrier frequency, at least one candidate base station of the first plurality of base stations receiving the capacity request, determining its net excess capacity based upon available forward link resources and available reverse link resources, and responding with a net excess capacity response; a second plurality of base stations coupled to the at least one base station controller, the second plurality of base stations operating on a second carrier frequency, at least one candidate base station of the second plurality of base stations receiving the capacity request, determining its net excess capacity based upon available forward link resources and available reverse link resources, and responding with a net excess capacity response; and the at least one base station controller operating to assign the mobile unit by selecting at least one servicing base station from the candidate base stations based upon the received net excess capacity responses by selecting the originating carrier frequency despite a higher priority for the other of the first and second carrier frequencies whenever adequate capacity is indicated in the excess capacity responses for the originating carrier frequency to at least one responding candidate base station of the first plurality of base stations or to at least one responding candidate base station of the second plurality of base stations based upon received net excess capacity responses.

2. The wireless communication system of claim 1 wherein inadequate capacity is indicated in the excess capacity responses for the originating carrier frequency, and further including:
the at least one base station controller selecting the other of the carrier frequencies than the originating carrier frequency.

3. The wireless communication system of claim 2, wherein at least one of the frequencies other than the originating carrier frequency has an assigned high priority, and further including:
the at least one base station controller waiting a specified time period for a capacity estimate response for carrier frequencies of the assigned high priority;
when the capacity estimate response from at least one of the high priority carrier frequencies is positive, the at least one base station controller selecting a servicing base station from the candidate base stations based upon the received positive excess capacity responses for the at least one of the high priority carrier frequencies; and
the at least one base station controller servicing the mobile unit with the selected servicing base station on the at least one of the high priority carrier frequencies.

4. A wireless communication system that provides wireless service to a mobile unit operating within a service area, the wireless communication system comprising:
a plurality of base station controllers in at least partially overlapping sectors, at least one of the base station controllers producing a capacity request in response to a request made by the mobile unit; the plurality of base station controllers each having a first plurality of base stations coupled to them, the first plurality of base stations operating on a first carrier frequency, at least one candidate base station of the first plurality of base stations receiving the capacity request, determining its net excess capacity based upon available forward link resources and available reverse link resources, and responding with a net excess capacity response; the plurality of base station controllers each further having a second plurality of base stations coupled to them, the second plurality of base stations operating on a second carrier frequency, the first and second carrier frequencies being in the same or different bands, at least one candidate base station of the second plurality of base stations receiving the capacity request, determining its net excess capacity based upon available forward link resources and available reverse link resources, and responding with a net excess capacity response; and the base station controllers operating to assign the mobile unit to a responding candidate base station of the plurality of base station controllers based upon received net excess capacity responses.

5. The wireless communication system of claim 4,wherein at least one of the frequencies other than the originating carrier frequency has an assigned high priority, and further including:
the at least one base station controller waiting a specified time period for a capacity estimate response for carrier frequencies of the assigned high priority;
when the capacity estimate response from at least one of the high priority carrier frequencies is positive, the at least one base station controller selecting a servicing base station from the candidate base stations based upon the received positive excess capacity responses for the high priority carrier frequency; and the at least one base station controller servicing the mobile unit with the selected servicing base station on the high priority carrier frequency.

6. A wireless communication system that provides wireless service to a mobile unit operating within a service area, the wireless communication system comprising:
at least one base station controller, the at least one base station controller producing a capacity request in response to a request made by the mobile unit; a first plurality of base stations coupled to the at least one base station controller, the first plurality of base stations operating on a first carrier frequency, at least one candidate base station of the first plurality of base stations receiving the capacity request, determining its net excess capacity based upon available forward link resources and available reverse link resources, and responding with a net excess capacity response; a second plurality of base stations coupled to the at least one base station controller, the second plurality of base stations operating on a second carrier frequency, the first and second carrier frequencies being in the same or different bands, at least one candidate base station of the second plurality of base stations receiving the capacity request, determining its net excess capacity based upon available forward link resources and available reverse link resources, and responding with a net excess capacity response;
at least one of the first and second carrier frequencies having an assigned high priority; and the at least one base station controller waiting a specified time period for a capacity estimate response for carrier frequencies of the assigned high priority and, when the capacity estimate response from the high priority carrier frequency is positive, operating to assign the mobile unit to at least one responding candidate base station of the first plurality of base stations or to at least one responding candidate base station of the second plurality of base stations based upon received net excess capacity response from the high priority carrier frequency.

7. The wireless communication system of claim 6, wherein only one of the carrier frequencies has an assigned high priority, and wherein the at least one base station controller waits the specified time period for a capacity estimate response of the carrier frequency of the assigned high priority.

8. The wireless communication system of claim 7, wherein no capacity response is received for the carrier frequency of the assigned high priority and the at least one base station controllers selecting a servicing base station based upon received positive excess capacity response for the other carrier frequency.

9. The wireless communication system of claim 6, wherein a plurality of the carrier frequencies have an assigned high priority, and wherein the at least one base station controller waits the specified time period for a capacity response of each carrier frequency of the assigned high priority.

10. The wireless communication system of claim 9, wherein no capacity response is received for the plurality of carrier frequencies with the assigned high priority, and wherein the at least one base station controller selects a servicing base station from the candidate base stations based upon the highest received positive excess capacity response.

11. A wireless communication system that provides wireless service to a mobile unit operating within a service area, the wireless communication system comprising:
a plurality of base station controllers in at least partially overlapping sectors, the base station controllers producing a capacity request in response to a request made by the mobile unit; at least one of the plurality of base station controllers having a first plurality of base stations coupled thereto, the first plurality of base stations operating on a first carrier frequency and a second carrier frequency, the first and second carrier frequencies being in the same or different bands, at least one candidate base station of the first plurality of base stations receiving the capacity request, determining its net excess capacity based upon available forward link resources and available reverse link resources, and responding with a net excess capacity response; at least one of the plurality of base station controllers having a second plurality of base stations coupled thereto, the second plurality of base stations operating only on one of the first and second carrier frequencies, at least one candidate base station of the second plurality of base stations receiving the capacity request, determining its net excess capacity based upon available forward link resources and available reverse link resources, and responding with a net excess capacity response; and the at least one base station controller operating if the excess capacity responses for the base stations in overlapping sectors indicate inadequate capacity on a first one of the first and second carrier frequencies to assign the mobile unit to at least one responding candidate base station of the first plurality of base stations on the other of the first and second carrier frequencies.

12. The wireless communication system of claim 11, wherein at least one of the first and second frequencies has an assigned high priority, and further including:
the at least one base station controller waiting a specified time period for a capacity estimate response for carrier frequencies of the assigned high priority;
when the capacity estimate response from at least one of the carrier frequencies of the assigned high priority is positive, the at least one base station controller selecting a servicing base station from the candidate base stations based upon the received positive excess capacity response for the high priority carrier frequency; and the at least one base station controller servicing the mobile unit with the selected servicing base station on the selected high priority carrier frequency.

13. In a wireless communication system including a first plurality of base stations that operate on a first carrier frequency and a second plurality of base stations that operate on a second carrier frequency, the first and second carrier frequencies being in the same or different bands, the first plurality of base stations and the second plurality of base stations providing overlaying service, a method of operation comprising:
receiving a request from a mobile unit on one of the first and second carrier frequencies as an originating carrier frequency; determining an operational position of the mobile unit based upon the location of a base station receiving the request; based upon the operational position of the mobile unit, requesting capacity information from candidate base stations of the first plurality of base stations and candidate base stations of the second plurality of base stations; receiving net excess capacity responses from the candidate base stations, each net excess capacity response based upon available forward link resources and available reverse link resources of a respective candidate base station; selecting at least one servicing base station from the candidate base stations based upon the received net excess capacity responses by selecting the originating carrier frequency despite a higher priority for the other of the first and second carrier frequencies whenever adequate capacity is indicated in the excess capacity responses for the originating carrier frequency; and servicing the mobile unit with the selected at least one servicing base station on the originating carrier frequency.

14. The method of claim 13, wherein inadequate capacity is indicated in the excess capacity responses for the originating carrier frequency during the step of receiving net excess capacity responses, and wherein the step of selecting comprises the step of:
selecting the other of the carrier frequencies than the originating carrier frequency.

15. The method of claim 14, wherein at least one of the frequencies other than the originating carrier frequency has an assigned high priority, and further including the steps of:
waiting a specified time period for a capacity estimate response for carrier frequencies of the assigned high priority;
when the capacity estimate response from at least one of the high priority carrier frequencies is positive, selecting a servicing base station from the candidate base stations based upon the received positive excess capacity responses for the at least one of the high priority carrier frequencies; and servicing the mobile unit with the selected servicing base station on the at least one of the high priority carrier frequencies.

16. In a wireless communication system including a plurality of base station controllers in at least partially overlapping sectors, at least one of the plurality of base station controllers having a first plurality of base stations that operate on a first carrier frequency and a second plurality of base stations that operate on a second carrier frequency, the first and second carrier frequencies being in the same or different bands, the first plurality of base stations and the second plurality of base stations providing overlaying service, a method of operation comprising:
receiving a request from a mobile unit; determining an operational position of the mobile unit based upon the location of a base station receiving the request; based upon the operational position of the mobile unit, requesting capacity information from candidate base stations of the first plurality of base stations and candidate base stations of the second plurality of base stations for base station controllers in sectors overlapping the location of the base station receiving the request; receiving net excess capacity responses from the candidate base stations, each net excess capacity response based upon available forward link resources and available reverse link resources of a respective candidate base station;
when the candidate base station is associated with a cell in which the mobile station accessed the wireless communication system, retaining that candidate base station as one of the candidate base stations;
selecting at least one servicing base station from the retained candidate base stations of the base station controllers in overlapping sectors based upon the received net excess capacity responses, the at least one servicing base station corresponding to either the first carrier frequency or the second carrier frequency; and servicing the mobile unit with the selected base station.

17. The method of claim 16, wherein at least one of the carrier frequencies has an assigned high priority, and further including the steps of:
waiting a specified time period for a capacity estimate response for carrier frequencies of the assigned high priority;
when the capacity estimate response from at least one of the high priority carrier frequencies is positive, selecting a servicing base station from the candidate base stations based upon the received positive excess capacity responses for the high priority carrier frequency; and servicing the mobile unit with the selected servicing base station on the high priority carrier frequency.

18. In a wireless communication system including a first plurality of base stations that operate on a first carrier frequency and a second plurality of base stations that operate on a second carrier frequency, the first and second carrier frequencies being in the same or different bands, the first plurality of base stations and the second plurality of base stations providing overlaying service, at least one of the frequencies for the base stations having an assigned high priority, a method of operation comprising:
receiving a request from a mobile unit; determining an operational position of the mobile unit based upon the location of a base station receiving the request; based upon the operational position of the mobile unit, requesting capacity information from candidate base stations of the first plurality of base stations and candidate base stations of the second plurality of base stations;
waiting a specified time period for a capacity estimate response for carrier frequencies of the assigned high priority; receiving net excess capacity responses from the candidate base stations, each net excess capacity response based upon available forward link resources and available reverse link resources of a respective candidate base station;
when the capacity estimate response from the high priority carrier frequency is positive, selecting a servicing base station from the candidate base stations based upon the received positive excess capacity responses for the high priority carrier frequency; and servicing the mobile unit with the selected servicing base station on the high priority carrier frequency.

19. The method of claim 18, wherein only one of the carrier frequencies has an assigned high priority, and wherein the step of waiting comprises:
waiting the specified time period for a capacity estimate response for the carrier frequency of the assigned high priority.

20. The method of claim 19, wherein no capacity response is received from the carrier frequency with the high priority, and wherein the step of selecting comprises the step of:
selecting a servicing base station from the candidate base stations based upon the received positive excess capacity responses for the next highest priority carrier frequency.

21. The method of claim 18, wherein a plurality of the carrier frequencies have an assigned high priority, and wherein the step of waiting comprises:
waiting the specified time period for a capacity estimate response for each carrier frequency of the assigned high priority.

22. The method of claim 21, wherein no capacity response is received from the plurality of carrier frequencies with the high priority, and wherein the step of selecting comprises the step of:
selecting a servicing base station from the candidate base stations based upon the highest received positive excess capacity response.

23. In a wireless communication system including a plurality of base station controllers in at least partially overlapping sectors, at least one of the plurality of base station controllers having a first plurality of base stations that operate on a first carrier frequency and a second plurality of base stations that operate on a second carrier frequency, the first and second carrier frequencies being in the same or different bands, the first plurality of base stations and the second plurality of base stations providing overlaying service, and at least one of the plurality of base station controllers having a base station that operates only on one of the first and second carrier frequencies, a method of operation comprising:
receiving a request from a mobile unit; determining an operational position of the mobile unit based upon the location of a base station receiving the request; based upon the operational position of the mobile unit, requesting capacity information from candidate base stations of the plurality of base station controllers in sectors overlapping the location of the base station receiving the request; receiving net excess capacity responses from the candidate base stations, each net excess capacity response based upon available forward link resources and available reverse link resources of a respective candidate base station; if the excess capacity responses for the base stations in overlapping sectors indicate inadequate capacity on a first one of the first and second carrier frequencies, selecting at least one servicing base station on the other of the first and second carrier frequencies from the candidate base stations of the base station controllers in overlapping sectors based upon the received net excess capacity responses; and servicing the mobile unit with the selected servicing base station.

24. The method of claim 23, wherein at least one of the first and second frequencies has an assigned high priority, and further including the steps of:
waiting a specified time period for a capacity estimate response for carrier frequencies of the assigned high priority;
when the capacity estimate response from at least one of the carrier frequencies of the assigned high priority is positive, selecting a servicing base station from the candidate base stations based upon the received positive excess capacity response for the high priority carrier frequency; and servicing the mobile unit with the selected servicing base station on the selected high priority carrier frequency.

25. A computer readable medium that is readable by at least one component of a wireless communication system that includes a first plurality of base stations that operate on a first carrier frequency and a second plurality of base stations that operate on a second carrier frequency and that supports a mobile unit, the first and second carrier frequencies being in the same or different bands, the first plurality of base stations and the second plurality of base stations providing overlaying service, the computer readable medium comprising:
a set of instructions that, when executed by the wireless communication system, cause the wireless communication system to perform the following operations: receive a request from a mobile unit on one of the first and second carrier frequencies as an originating carrier frequency; determine an operational position of the mobile unit based upon the location of a base station receiving the request; based upon the operational position of the mobile unit, request capacity information from candidate base stations of the first plurality of base stations and candidate base stations of the second plurality of base stations; receive net excess capacity responses from the candidate base stations, each net excess capacity response based upon available forward link resources and available reverse link resources for a respective candidate base station; select at least one servicing base station at the originating carrier frequency from the candidate base stations based upon the received net excess capacity responses, despite a higher priority for the other of the first and second carrier frequencies, whenever adequate capacity is indicated in the excess capacity responses for the originating carrier frequency; and service the mobile unit with the selected servicing base station on the originating carrier frequency.

26. The computer readable medium of claim 25, wherein the set of instructions includes instructions that cause the wireless communication system to:
select the other of the carrier frequencies than the originating carrier frequency when inadequate capacity is indicated in the responses for the originating carrier frequency.

27. The computer readable medium of claim 26, wherein at least one of the frequencies other than the originating carrier frequency has an assigned high priority, and wherein the set of instructions includes instructions that cause the wireless communication system to:
wait a specified time period for a capacity estimate response for carrier frequencies of the assigned high priority;
when the capacity estimate response from at least one of the high priority carrier frequencies is positive, select a servicing base station from the candidate base stations based upon the received positive excess capacity responses for the at least one of the high priority carrier frequencies; and service the mobile unit with the selected servicing base station on the at least one of the high priority carrier frequencies.

28. A computer readable medium that is readable by at least one component of a wireless communication system that includes a plurality of base station controllers in at least partially overlapping sectors, at least one of the plurality of base station controllers having a first plurality of base stations that operate on a first carrier frequency and a second plurality of base stations that operate on a second carrier frequency and that supports a mobile unit, the first and second carrier frequencies being in the same or different bands, the first plurality of base stations and the second plurality of base stations providing overlaying service, the computer readable medium comprising:
a set of instructions that, when executed by the wireless communication system, cause the wireless communication system to perform the following operations: receive a request from a mobile unit; determine an operational position of the mobile unit based upon the location of a base station receiving the request; based upon the operational position of the mobile unit, request capacity information from candidate base stations of the plurality of base station controllers and candidate base stations of the second plurality of base stations; receive net excess capacity responses from the candidate base stations, each net excess capacity response based upon available forward link resources and available reverse link resources for a respective candidate base station; select at least one servicing base station from the candidate base stations of the base station controllers in overlapping sectors based upon the received net excess capacity responses, the at least one servicing base station corresponding to either the first carrier frequency or the second carrier frequency; and service the mobile unit with the selected servicing base station.

29. The computer readable medium of claim 28, wherein at least one of the carrier frequencies has an assigned high priority, and wherein the set of instructions includes instructions that cause the wireless communication system to:
wait a specified time period for a capacity estimate response for carrier frequencies of the assigned high priority;
when the capacity estimate response from at least one of the high priority carrier frequencies is positive, select a servicing base station from the candidate base stations based upon the received positive excess capacity responses for the high priority carrier frequency; and service the mobile unit with the selected servicing base station on the high priority carrier frequency.

30. A computer readable medium that is readable by at least one component of a wireless communication system that includes a first plurality of base stations that operate on a first carrier frequency and a second plurality of base stations that operate on a second carrier frequency and that supports a mobile unit, the first and second carrier frequencies being in the same or different bands, the first plurality of base stations and the second plurality of base stations providing overlaying service, at least one of the base stations having an assigned high priority, the computer readable medium comprising:
a set of instructions that, when executed by the wireless communication system, cause the wireless communication system to perform the following operations: receive a request from a mobile unit; determine an operational position of the mobile unit based upon the location of a base station receiving the request; based upon the operational position of the mobile unit, request capacity information from candidate base stations of the first plurality of base stations and candidate base stations of the second plurality of base stations;
wait a specified time period for a capacity estimate response for carrier frequencies of the assigned high priority;
receive net excess capacity responses from the candidate base stations, each net excess capacity response based upon available forward link resources and available reverse link resources for a respective candidate base station; if the capacity estimate response from the highest priority carrier frequency is positive, select a servicing base station from the candidate base stations based upon the positive net excess capacity responses for the highest priority carrier frequency; and service the mobile unit with the selected servicing base station on the highest priority carrier frequency.

31. The computer readable medium of claim 30, wherein the set of instructions includes instructions that cause the wireless communication system to:
wait the specified time period for a capacity estimate response for the carrier frequency of the assigned high priority.

32. The computer readable medium of claim 31, wherein the set of instructions includes instructions that cause the wireless communication system to:
select a servicing base station from the candidate base stations based upon the received positive excess capacity responses for the next highest priority carrier frequency.

33. The computer readable medium of claim 30, wherein the set of instructions includes instructions that cause the wireless communication system to:
wait the specified time period for a capacity estimate response for each carrier frequency of the assigned high priority.

34. The computer readable medium of claim 33, wherein the set of instructions includes instructions that cause the wireless communication system to:
select a servicing base station from the candidate base stations based upon the highest received positive excess capacity response.

35. A computer readable medium that is readable by at least one component of a wireless communication system that includes a plurality of base station controllers in at least partially overlapping sectors, at least one of the plurality of base station controllers having a first plurality of base stations that operate on a first carrier frequency and a second plurality of base stations that operate on a second carrier frequency and that supports a mobile unit, the first and second carrier frequencies being in the same or different bands, the first plurality of base stations and the second plurality of base stations providing overlaying service, and at least one of the plurality of base station controllers having a base station that operates only on one of the first and second carrier frequencies, the computer readable medium comprising:
a set of instructions that, when executed by the wireless communication system, cause the wireless communication system to perform the following operations: receive a request from a mobile unit; determine an operational position of the mobile unit based upon the location of a base station receiving the request; based upon the operational position of the mobile unit, request capacity information from candidate base stations of the plurality of base station controllers; receive net excess capacity responses from the candidate base stations, each net excess capacity response based upon available forward link resources and available reverse link resources for a respective candidate base station; if the excess capacity responses for the base stations in overlapping sectors indicate inadequate capacity on a first one of the first and second carrier frequencies, select at least one servicing base station of the base station controllers in overlapping sectors on the other of the first and second carrier frequencies from the candidate base stations based upon the received net excess capacity responses, the at least one servicing base station corresponding to either the first carrier frequency or the second carrier frequency; and service the mobile unit with the at selected servicing base station.

36. The computer readable medium of claim 35, wherein at least one of the carrier frequencies has an assigned high priority, and wherein the set of instructions includes instructions that cause the wireless communication system to:
wait a specified time period for a capacity estimate response for carrier frequencies of the assigned high priority;
when the capacity estimate response from at least one of the carrier frequencies of the assigned high priority is positive, select a servicing base station from the candidate base stations based upon the received positive excess capacity response for the high priority carrier frequency; and service the mobile unit with the selected servicing base station on the selected high priority carrier frequency.
